(19) United States
(12) Patent Application Publication
(10) Pub. No.: US 2008/0180940 A1
(43) Pub. Date: Jul. 31, 2008

(54) Twinkling and glowing textile product

(76) Inventor: Wei-Jei Tuan, Sindian (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/657,627

(22) Filed: Jan. 25, 2007

(51) Int. Cl. F21V 21/00; F21L 4/02

(52) U.S. Cl. 362/103; 362/185

(57) ABSTRACT

A twinkling and glowing textile product includes a twinkling lamp mechanism which combines with a decoration combining with a textile body. The twinkling lamp mechanism includes a glowing circuit assembly, a battery, a vibrating switch assembly and a plastic element. The glowing circuit assembly includes a first circuit board, a control IC and a plurality of light emitting diodes. The battery electrically connects with the glowing circuit assembly for supplying needed power. The vibrating switch assembly electrically connects with the first circuit board. The plastic element is transparent and packages the glowing circuit assembly, the battery and the vibrating switch assembly. When the vibrating switch assembly is vibrated, the light emitting diodes is driven to glow and twinkle in turn, which offers splendid effects when the textile body is used.

### BACKGROUND OF THE INVENTION

1. Field of the Invention

The present invention relates to a twinkling lamp mechanism, and more especially to a twinkling lamp mechanism for textile products, which can glow and twinkle when vibrated.

2. Description of the Prior Art

As standard of living improves, that products only have basic functions cannot meet consumers' demands. For example, clothing not only needs to provide a function of keeping out the cold, but also needs to look well; shoes not only need to provide people's feet, but also needs to have a novel shape. Thereby besides the basic functions, the products have a higher additional value to attract attention of consumers.

Basing on the development of technology, many electric assemblies can be used to emit glowing and twinkling light, which mainly is achieved via engagements of the electric assemblies such as control ICs and so on and light emitting diodes. On the market, shoes or backpacks with vibrating and twinkling devices have the effects of attracting the attention of people due to the glow and twinkle as the wearer walks.

However, as the novelty wears off, shoes or backpacks with vibrating and twinkling devices become passe and unfashionable. Furthermore, with the development of technology, related industries are pursuing the objectives of improving the vibrating and twinkling device structure and application to allow the vibrating and twinkling devices to be used in things other than shoes or backpacks. Additionally, it is worth mentioning that most vibrating switches for the vibrating and twinkling lamps make the circuits conduct via swinging contact of springs mounted inside the shoe or backpack. If the amplitude of vibration of the vibrating switches is too small, the circuits will not conduct and produce twinkling effects.

Hence, the inventors of the present invention believe that the shortcomings described above are able to be improved and finally suggest the present invention which is of a reasonable design and is an effective improvement based on deep research and thought.

### SUMMARY OF THE INVENTION

An object of the present invention is to provide a twinkling and glowing textile product which is more interesting and offers more splendid effects to meet changeable demands of consumers, and at the same time, has a sensitive glowing and twinkling effect to ensure that the desired glowing and twinkling actions occur.

To achieve the above-mentioned object, a twinkling and glowing textile product in accordance with the present invention is disclosed. The twinkling and glowing textile product includes a textile body; a decoration mounted on a surface of the textile body; and more than one twinkling lamp mechanisms combining with the decoration. Each twinkling lamp mechanism includes a glowing circuit assembly which includes a first circuit board, a control IC and a plurality of light emitting diodes, wherein the first circuit board forms circuits on and the control IC and the plurality of light emitting diodes are mounted on the first circuit board and respectively electrically connect with the circuits on the first circuit board; at least one battery electrically connecting with the glowing circuit assembly for supplying needed power; a vibrating switch assembly which includes a second circuit board, an insulating shell and at least one metal bead, wherein the second circuit board electrically connects with the circuits on the first circuit board and forms a plurality of first conducting portions and second conducting portions, the insulating shell combines with the second circuit board and has a receiving room inside, the first conducting portions and the second conducting portions are in the receiving room, and the at least one metal bead is rollably received in the receiving room; and a transparent plastic element which packages the glowing circuit assembly, the at least one battery and the vibrating switch assembly.

When the vibrating switch assembly is vibrated, the at least one metal bead contacts with one of the first conducting portions and the second conducting portions thereby a trigger signal is generated and when receiving the trigger signal, the control IC generates a driving signal to drive the light emitting diodes to twinkle within a twinkling time.

To further understand technical contents, methods and efficacy of the present invention, please refer to the following detailed description and drawings related the present invention. It is believed that the objects, features and points of the present invention can be deeply understood. However, the drawings are only to be used as references and explanations, not to limit the present invention.

### BRIEF DESCRIPTION OF THE DRAWINGS

FIG. 1 is an exploded perspective view of a twinkling lamp mechanism in accordance with the present invention;

FIG. 2 is a partially assembled perspective view of the twinkling lamp mechanism in accordance with the present invention;

FIG. 3 is an assembled perspective view of the twinkling lamp mechanism in accordance with the present invention;

FIG. 4 is a circuit wiring diagram of the twinkling lamp mechanism in accordance with the present invention;

FIG. 5 is a circuit block diagram of the twinkling lamp mechanism in accordance with the present invention;

FIG. 6 is a sketched view of the twinkling lamp mechanism in accordance with the present invention combined with a decoration and a textile body.

### DETAILED DESCRIPTION OF THE INVENTION

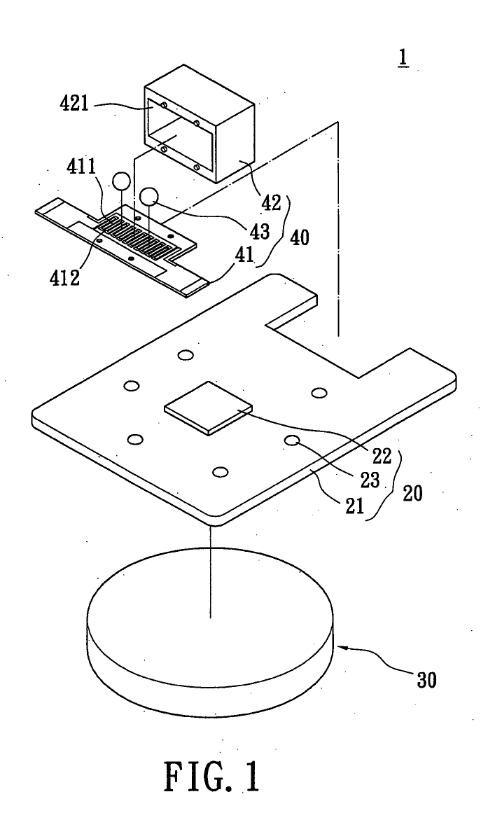

Please referring to FIGS. 1-3, a twinkling lamp mechanism 1 in accordance with a preferred embodiment of the present invention is shown. The twinkling lamp mechanism 1 includes a glowing circuit assembly 20, at least one battery 30, a vibrating switch assembly 40 and a plastic element 50, and can further include a shell 60.

The glowing circuit assembly 20 includes a first circuit board 21, a control IC 22 and a plurality of LEDs (Light Emitting Diodes) 23. The first circuit board 21 is approximately shaped like a square and form circuits (not shown) on. The control IC 22 is mounted on a surface of the first circuit board 21 and electrically connects with the circuits on the first circuit board 21. Each LED 23 is directly mounted on a surface of the first circuit board 21 and electrically connects with the circuits on the first circuit board 21. The quantity of the LEDs 23 is determined by actual demand. In the figures of this embodiment, the glowing circuit assembly 20 has six LEDs 23 for example.

Each LED 23 can be a multi-colored LED, a single colored LED, or a combination thereof. Further explaining, a multi-colored LED 23 includes a plurality of LED chips (not shown) with different colors (such as three colors including red, green and blue) and is directly mounted on the first circuit board 21 for producing lights with multi-combinations of different colors. A single colored LED 23 has a LED chips with a single color (such as yellow and so on) and is directly mounted on the first circuit board 21 for producing single color lights.

The battery 30 can be a power supply element such as Lithium Battery and so on. The battery 30 electrically connects to the other surface of the first circuit board 21 for supplying needed power. The quantity of the battery 30 is determined by actual demand. In the figures of this embodiment, the twinkling lamp mechanism 1 has one battery 30 for example.

The vibrating switch assembly 40 includes a second circuit board 41, an insulating shell 42 and at least one metal bead 43. The second circuit board 41 is smaller than the first circuit board 21 in size. A plurality of first conducting portions and second conducting portions (i.e. anodes and cathodes) are parallel and interlacedly arranged on the second circuit board 41.

The insulating shell 42 can be made of an insulation material, such as plastic, rubber and so on. The insulating shell 42 is approximately shaped like a square and can be transparent. A receiving room 421 is formed concavely inwards from a surface of the insulating shell 42. The metal bead 43 can be made of metal material with electrical conductivity such as copper and so on. The vibrating switch assembly 40 can have one or two metal beads 43. In the figures of this embodiment, the vibrating switch assembly 40 has two metal beads 43 for example.

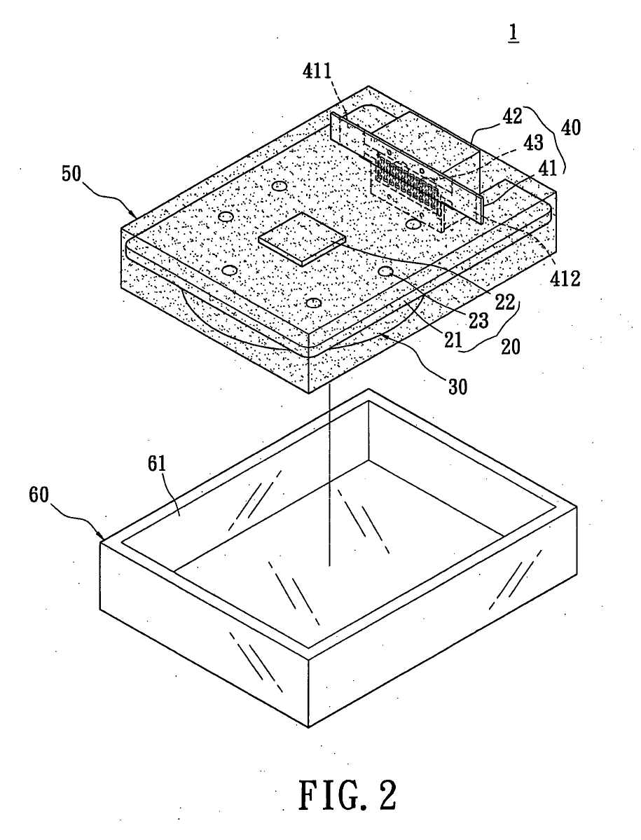

Please referring to FIG. 1 and FIG. 2. At first, receive the metal beads 43 in the receiving room 421 of the insulating shell 42. Then, mount the insulating shell 42 on the surface of the second circuit board 41 by adhering or fastening to receive the first and the second conducting portions 411, 412 in the receiving room 421. Finally, engage the second circuit board with the first circuit board so that the first and the second conducting portions 411, 412 can electrically connect with the circuits of the first circuit board 21.

Please referring to FIG. 2. The plastic element 50 is made of translucent plastic and fully packages the glowing circuit assembly 20, the battery 30 and the vibrating switch assembly 40 inside via an injection molding method. The plastic element 50 is transparent so that light emitted by the LEDs 23 can pass through the plastic element 50.

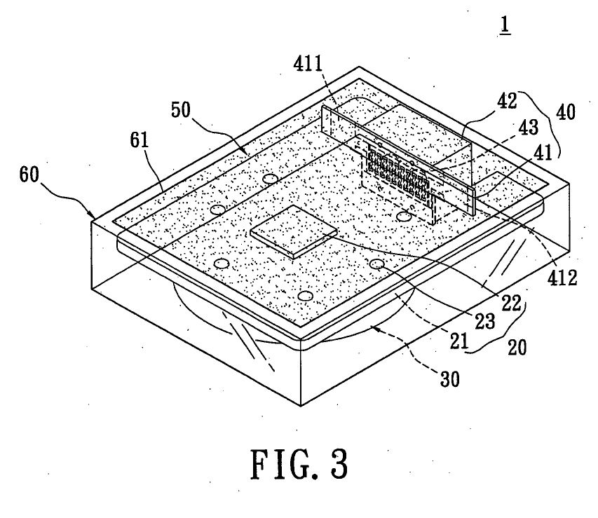

Please referring to FIG. 2 and FIG. 3. The shell 60 is made of translucent plastic and forms a cavity 61 concavely downwards from an upper surface thereof. The cavity 61 can receive the above plastic element 50, the glowing circuit assembly 20, the battery 30 and the vibrating switch assembly 40. Alternatively, firstly, receive the glowing circuit assembly 20, the battery 30 and the vibrating switch assembly 40 in the cavity 61 and then mount the translucent plastic element 50 in the cavity 61 via an encapsulating method to package the glowing circuit assembly 20, the battery 30 and the vibrating switch assembly 40 inside the plastic element 50 in order to achieve a waterproof function.

Accordingly, when the twinkling lamp mechanism 1 of the present invention vibrates under the influence of an external force, the metal beads 43 rolls and simultaneously contact with any one of the first conducting portions 411 and the second conducting portions 412. So that the vibrating switch assembly 40 can electrically connect with the circuits of the first circuit board 21 to make the LEDs 23 glow and twinkle.

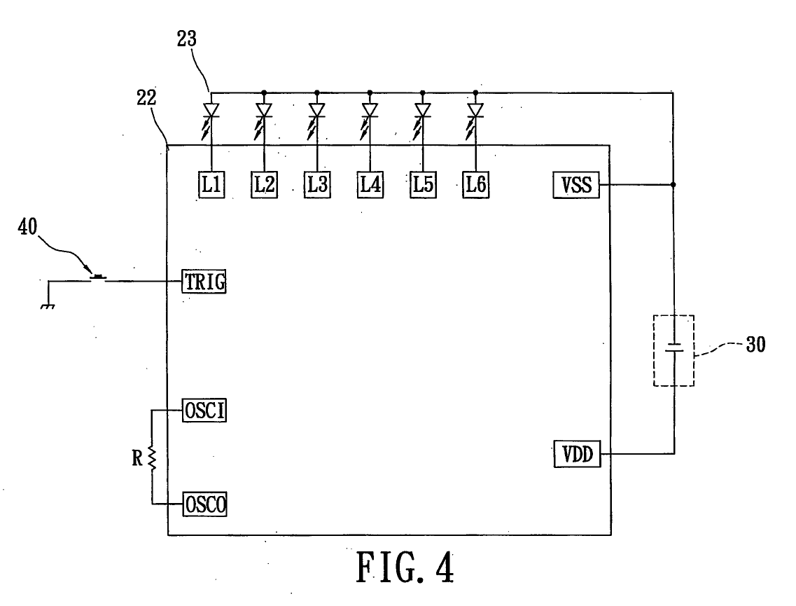

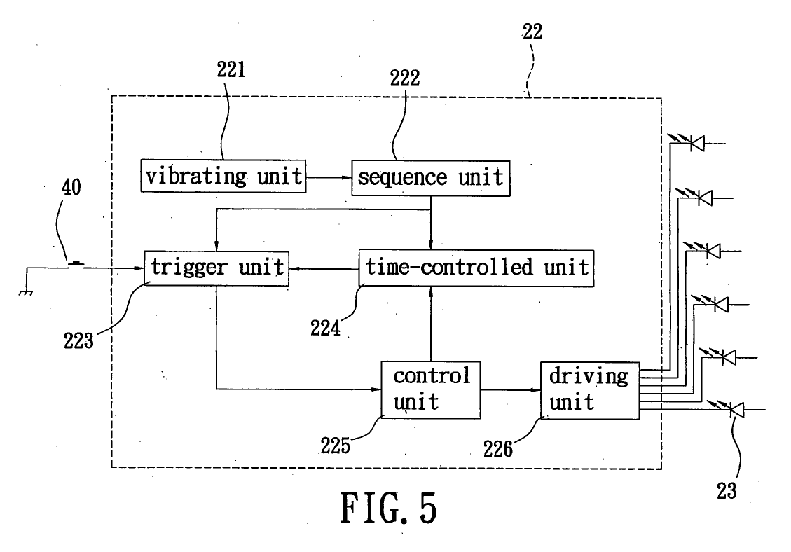

Please referring to FIG. 4 and FIG. 5. The control IC electrically connects with each LED 23, the battery 30, the vibrating switch assembly 40 and a vibrating resistance R via circuits on a circuit board (not shown). The control IC 22 includes a vibrating unit 221, a sequence unit 222, a trigger unit 223, a time-controlled unit 224, a control unit 225 and a driving unit 226.

The above vibrating unit 221 and sequence unit 222 generate a work frequency for the trigger unit 223 and the time-controlled unit 224. The trigger unit 223 electrically connects with the vibrating switch assembly 40 and generates a trigger signal for the control unit 225 when the vibrating switch assembly 40 is vibrated. The time-controlled unit 224 determines that the control IC 22 generates a driving signal and transmits the driving signal to the LEDs 23 within a twinkling time after receiving the trigger signal and cause a short circuit to disable a new trigger signal which is generated within the twinkling time, thereby to avoid delay of the twinkling time. After receiving the driving signal from the control unit 225, the driving unit 226 controls and drives each LED 20 to glow and twinkle.

Accordingly, the trigger unit 223 generates the trigger signal for the control unit 225 when the vibrating switch assembly 40 is vibrated. At this time, the LEDs 20 twinkle in turn within the twinkling time determined by the time-controlled unit 224. Additionally, because the metal beads 43 have good electrical conductivity of metal and are easy to roll, the vibrating switch assembly 40 has a sensitive electrical conductivity effect via the engagement of the metal heads 43 and the first and the second conducting portions 411, 412 of the second circuit board 41 to ensure that the desired glowing and twinkling actions occur because the amplitude of vibration is large enough.

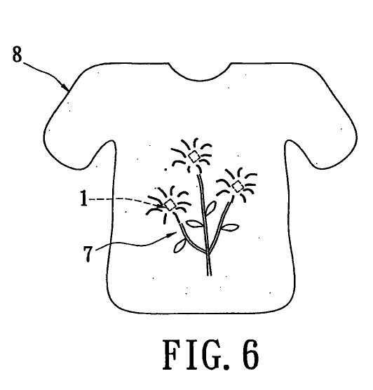

Please referring to FIG. 6. The twinkling lamp mechanism 1 of the present invention can be combined with a decoration 7 and the decoration 7 can be further combined with a textile body 8. Furthermore, the decoration 7 can arrange one twinkling lamp mechanism 1 or a plurality of twinkling lamp mechanism 1 therein based upon actual demand. The decoration 7 is not limited to a certain shape and can be a cartoon pattern, an animal form, a human form or a decorative pattern etc. The textile body 8 can be a household supply, such as an article of clothing, a sock or a cap for example. In the figure of this embodiment, the textile body 8 is an article of clothing and the decoration 7 is a decorative pattern.

The above decoration 7 can be a badge made of PVC (polyvinyl chloride) material. The badge is formed via heatedly pressing a front piece and a rear piece to each other. Firstly dispose the twinkling lamp mechanism 1 of the present invention between the front piece and the rear piece and then engage the front piece with the rear piece via heatedly pressing to combine the twinkling lamp mechanism 1 with the badge. Finally, mount the badge on an outer surface of the textile body 8.

Alternatively, the decoration 7 can be made of plastic and hollow to receive the twinkling lamp mechanism 1 of the present invention. Then the plastic is combined with an outer surface of the textile body 8 via machine sewing.

In sum, when a user is wearing the textile body 8, the vibrating switch assembly 40 is vibrated and the LEDs 20 can glow and twinkle in turn as the user moves, which makes the body 8 more interesting and offers splendid effects to need people's requirements. The twinkling lamp mechanism 1 of the present invention is waterproof and ensures that the twinkling lamp mechanism 1 is not damaged or loses efficacy due to water that comes in contact with the body.

What is disclosed above is only the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A twinkling and glowing textile product, comprising:
a textile body;
a decoration, mounted on a surface of the textile body; and
more than one twinkling lamp mechanisms, combining with the decoration and each including:
a glowing circuit assembly, including a first circuit board, a control IC and a plurality of light emitting diodes, wherein the first circuit board forms circuits on and the control IC and the plurality of light emitting diodes are mounted on the first circuit board and respectively electrically connect with the circuits on the first circuit board;
at least one battery, electrically connecting with the glowing circuit assembly for supplying needed power;
a vibrating switch assembly including a second circuit board, an insulating shell and at least one metal bead, wherein the second circuit board electrically connects with the circuits on the first circuit board and forms a plurality of first conducting portions and second conducting portions, the insulating shell combines with the second circuit board and has a receiving room inside, the first conducting portions and the second conducting portions are in the receiving room, and the at least one metal bead is rollably received in the receiving room; and
a transparent plastic element, packaging the glowing circuit assembly, the at least one battery and the vibrating switch assembly; wherein
when the vibrating switch assembly is vibrated, the at least one metal bead contacts with one of the first conducting portions and the second conducting portions thereby a trigger signal is generated and when receiving the trigger signal, the control IC generates a driving signal to drive the light emitting diodes to twinkle within a twinkling time.

2. The twinkling and glowing textile product as claimed in claim 1, wherein the textile body is an article of clothing, a sock or a cap.

3. The twinkling and glowing textile product as claimed in claim 1, wherein the decoration is a badge.

4. The twinkling and glowing textile product as claimed in claim 1, wherein the decoration is combined with the textile body via machine sewing.

5. The twinkling and glowing textile product as claimed in claim 1, wherein the control IC includes;
a trigger unit, electrically connecting with the vibrating switch assembly and generating the trigger signal;
a driving unit, driving the light emitting diodes to glow;
a control unit, receiving the trigger signal and generating the driving signal for the driving unit to make the light emitting diodes twinkle in turn; and
a time-controlled unit for determining the twinkling time.

6. The twinkling and glowing textile product as claimed in claim 1, wherein the light emitting diodes are multi-colored light emitting diodes, single colored light emitting diodes or a combination thereof.

7. The twinkling and glowing textile product as claimed in claim 1, wherein the first conducting portions and the second conducting portions are parallel and interlacedly arranged on the second circuit board.

8. The twinkling and glowing textile product as claimed in claim 1, wherein the insulating shell is transparent and the receiving room is formed concavely inwards from a surface of the insulating shell.

9. The twinkling and glowing textile product as claimed in claim 1, wherein the trigger signal generated in the twinkling time is disabled via a short circuit caused by the control IC.

10. The twinkling and glowing textile product as claimed in claim 1, wherein each twinkling lamp mechanism further includes a translucent shell, the shell has a cavity and the plastic element, the glowing circuit assembly, the at least one battery and the vibrating switch assembly are mounted in the cavity.
